(19) United States
(12) Patent Application Publication
(10) Pub. No.: US 2010/0057733 A1
(43) Pub. Date: Mar. 4, 2010

(54) METHOD, COMPUTER PROGRAM PRODUCT, AND APPARATUS FOR ENABLING ACCESS TO ENTERPRISE INFORMATION

(76) Inventors: Suresh Ravinarayanan Purisai, Bangalore (IN); Jerry Ibrahim, Laguna Beach, CA (US); Jim Schwaller, Wilmington, CA (US); Lakshmi Preethi Karthikeyan, Colmbatore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/203,009

(22) Filed: Sep. 2, 2008

(51) Int. Cl. G06F 17/30

(52) U.S. Cl. 707/6; 707/E17.039

(57) ABSTRACT

A method for enabling access to enterprise information may include analyzing text including a plurality of text strings and identifying a defined pattern within the text strings as corresponding to a particular entity. The particular entity may be associated with different classes of information stored in at least two respective different storage environments. The method may further include enabling provision of a selectable option providing access to one of the different classes of information from a corresponding one of the at least two respective different storage environments in response to selection of the selectable option.

### FIELD OF THE INVENTION

Embodiments of the present invention relate generally to information management systems, and more particularly, to a mechanism for enabling access to different classes of information related to a single item that may be identified from a text string.

### BACKGROUND OF THE INVENTION

Many large companies or enterprises conduct operations in different geographic regions. Additionally, such companies often have distinct programs or business units within either the same or different geographic regions. For example, a company may have separate programs for each type of good or service the company produces. Each of the programs may utilize a number of parts or materials, some of which may also be utilized in various other programs. However, despite the fact that similar resources may be utilized by different units or programs, it is common for each program to manage its parts or materials separately, and in some cases also the information related to its parts or materials. Accordingly, the practice of enterprise resource management has become of interest to many such companies in order to streamline the management of parts and materials.

In many instances, different classes of information may be related to the same part or product. For example, information regarding the operation or a product from an engineering or manufacturing perspective, such as a bill of materials (BOM) or information on where a part or product is used and costs of the components thereof, may be stored in a particular environment, while engineering design information such as product design drawings, specifications, testing requirements, processes for running, etc., may be stored in a different environment (e.g., a product data management system (PDM)). Access to the different classes of information may typically be provided through relatively complex interface mechanisms and storage environments. Moreover, the interface mechanisms and storage environments may be unique to each different class of information. Thus, in some circumstances, those who do not routinely access such information may find the mechanisms for achieving such access to be cumbersome or confusing to use, or some individuals simply may not know how to access such information. Accordingly, man-hours may be lost by individuals searching for information (or searching for information on how to access the information they desire) and productivity may decline.

It may be desirable to provide a mechanism capable of overcoming the problems described above by enabling different classes of information that may be related to a single item (e.g., a part number, cost center, etc.) to be easily accessed within an enterprise rather than just within particular programs of the enterprise or by particular people with expertise in accessing such information.

### BRIEF SUMMARY OF THE INVENTION

In order to improve capabilities with respect to accessing different classes or types of information related to a single item, some embodiments of the present invention may provide a mechanism for identifying a text string or pattern related to a particular item. Information related to the particular item, and in some cases different types of information that may be associated with different data storage systems or environments, may be made accessible via a link, icon, or other functionality for enabling access to such information that may be directly associated with the text string or pattern indicative of the particular item. Thus, for example, a text string corresponding to a part number may be identified and assigned a smart tag. In response to selection of the smart tag, web services may be employed to enable access to different classes of information such as, for example, either operational information regarding a part number or product design information.

In one exemplary embodiment, a method for enabling access to enterprise information is provided. The method may include analyzing text including a plurality of text strings and identifying a defined pattern within the text strings as corresponding to a particular entity. The particular entity may be associated with different classes of information stored in at least two respective different storage environments. The method may further include enabling provision of a selectable option providing access to one of the different classes of information from a corresponding one of the at least two respective different storage environments in response to selection of the selectable option.

In another exemplary embodiment, a computer program product for enabling access to enterprise information is provided. The computer program product includes at least one computer-readable storage medium having computer-readable program code portions stored therein. The computer-readable program code portions include multiple executable portions. In this regard, the first executable portion may be for analyzing text including a plurality of text strings. The second executable portion may be for identifying a defined pattern within the text strings as corresponding to a particular entity. The particular entity may be associated with different classes of information stored in at least two respective different storage environments. The third executable portion may be for enabling provision of a selectable option providing access to one of the different classes of information from a corresponding one of the at least two respective different storage environments in response to selection of the selectable option.

In another exemplary embodiment, an apparatus for enabling access to enterprise information is provided. The apparatus may include a pattern identifier and an information retriever. The pattern identifier may be configured to analyze text including a plurality of text strings and identify a defined pattern within the text strings as corresponding to a particular entity. The particular entity may be associated with different classes of information stored in at least two respective different storage environments. The information retriever may be configured to enable provision of a selectable option providing access to one of the different classes of information from a corresponding one of the at least two respective different storage environments in response to selection of the selectable option.

Embodiments of the present invention may therefore provide a mechanism for enabling relatively easy access to enterprise information or other types of information related to an identifiable text string or pattern. Furthermore, in some embodiments, the provided mechanism may incorporate credentials management to reduce transaction times for future interactions. As a result, productivity of the enterprise may be increased.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system for enabling access to enterprise information according to an exemplary embodiment of the present invention;

FIG. 2 is a basic block diagram of an apparatus for enabling access to enterprise information according to an exemplary embodiment of the present invention;

FIG. 3 (including FIGS. 3A, 3B and 3C) examples of smart tags and operation with respect to smart tags according to exemplary embodiments of the present invention; and

FIG. 4 is a flowchart according to an exemplary method of enabling access to enterprise information according to one embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

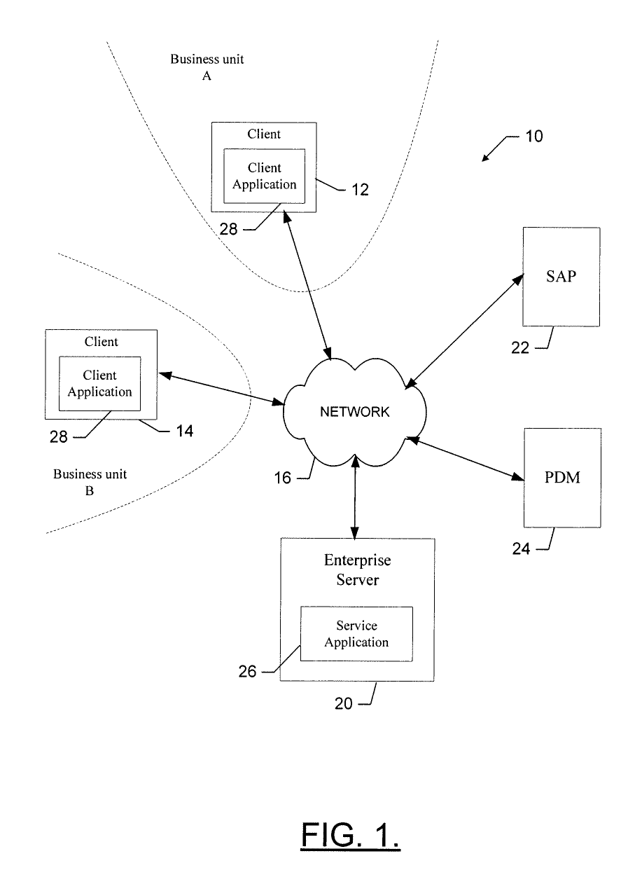

FIG. 1 is a basic block diagram illustrating a system 10 for enabling access to enterprise information according to an exemplary embodiment. It should be noted that while FIG. 1 will be described mainly in the context of parts-related information, embodiments of the present invention are not limited to applications related to part information. For example, other informational items that may be associated with or identified by a particular pattern or text sequence may also be utilized in connection with some embodiments. Thus, the description of parts-related information and the corresponding system description that follows should be understood to be exemplary of one system for employing an embodiment of the present invention and should not be treated as limiting with respect to other systems that may utilize embodiments of the present invention.

As shown in FIG. 1, the system 10 may include one or more clients that may, in some cases, be associated with different corresponding business units of an enterprise. For example, a first client (e.g., client 12) may be associated with a first business unit (e.g., business unit A) and a second client (e.g., client 14) may be associated with a second business unit (e.g., business unit B). The business units may be geographically collocated or remote from each other and may be distinct development programs, departments, businesses within a conglomerate, and/or the like. In some cases, more than one client may be included in the system 10 from each business unit and/or more than just the two business units shown may also be included in the system 10. Many other types of information may also be managed by embodiments of the present invention, including but not limited to those mentioned herein. The clients 12 and 14 may be personal computers, laptop computers, mobile or fixed communication terminals, or other communication devices that are capable of communication with a network 16.

The network 16 may be a data network, such as a local area network (LAN), a metropolitan area network (MAN), a wide area network (WAN) (e.g., the Internet), and/or the like, which may couple the clients 12 and 14 to devices such as processing elements (e.g., personal computers, server computers or the like) or databases. Communication between the network 16, the clients 12 and 14 and the devices or databases (e.g., servers) to which the clients 12 and 14 are coupled may be accomplished by either wireline or wireless communication mechanisms and corresponding protocols.

In an exemplary embodiment, one of the devices to which the clients 12 and 14 may be coupled via the network 16 may include an enterprise server 20. The enterprise server 20 may include hardware and/or software for configuring the enterprise server 20 to perform various functions. As such, for example, the enterprise server may include processing logic and memory enabling the enterprise server 20 to access and/or execute stored computer readable instructions for performing various functions. In an exemplary embodiment, one function that may be provided by the enterprise server 20 may be the provision of enterprise information to the clients 12 and 14. Additionally or alternatively, the enterprise server 20 may be configured to enable the clients 12 and 14 to access different classes of information that may be related to a common or same item. In this regard, for example, a first class of information (e.g., information on the operation of a product such as BOM information, information on where a product or part is used, cost, or the like) may be associated with or stored in a first data management environment (e.g., SAP 22), while a second class of information (e.g., information related to product design, drawing information, specifications, processes for testing or running, or the like) may be associated with or stored in a second data management environment (e.g., PDM 24). Access to information in additional other data management environments (or different data management environments) may also be provided in some embodiments.

In some embodiments, the enterprise server 20 may store and/or execute a service application 26 that may include instructions for configuring the enterprise server 20 (e.g., upon execution of the stored instructions) to provide a mechanism for enabling the clients 12 and 14 to access a selected type or class of information associated with a particular text string or pattern in response to recognition of the particular text string or pattern within a document being served or to be served to a respective one of the clients 12 and 14. In some cases, the provision of such mechanism may include the provision or definition of text strings or patterns and corresponding functionalities associated with the text strings or patterns and/or the service of a link, icon or other functional indicia (e.g., an indicator of a corresponding function available upon selection thereof) to a client on the basis of an identified text string or pattern. As such, for example, the service application 26 may include executable instructions for configuring the enterprise server 20 to identify text strings and/or patterns and provide corresponding functionalities or options for functionalities to a respective one of the clients 12 and 14 in response to selection of a link, icon or other functional indicia associated with an identified text string and/or pattern. Alternatively, the service application 26 may include executable instructions for configuring the enterprise server 20 to define a pattern or text string to be recognized and to further define, for the pattern or text string, what options with respect to functionality are to be associated with selection of the link, icon or other functional indicia associated with the pattern or text string for provision to a user of a client in response to selection thereof.

In some cases, the enterprise server 20 may be configured to operate on documents, files or other content items in a particular format or formats. For example, in one embodiment, documents associated with Microsoft Office (e.g., MS Word, Excel, Powerpoint, Outlook, or the like) may be parsed by the enterprise server 20 for inclusion of patterns or text strings that may trigger or initiate embodiments of the present invention to operate. However, other forms or formats of documents may also be supported dependent upon the implementation desired.

In an exemplary embodiment, each of the clients 12 and 14 may include a corresponding client application 28 that may include instructions for configuring the respective client to identify a defined text string or pattern for which the enterprise server 20 has defined a corresponding functionality (or is aware of a defined corresponding functionality). As such, in some cases, the client application 28 (instead of the service application 26) may parse documents received or being created at the client to identify the defined text string or pattern. Thus, the client application 28 may communicate with the enterprise application 26, either continuously or at discrete intervals (e.g., for synchronization), to receive information on defined text strings and/or patterns and the corresponding functions available for each respective defined text string and/or pattern. After identifying a defined text string or pattern, the client application 28 may display an icon, link or other functional indicia indicative of the fact that a corresponding functionality related to accessing enterprise information may be accessed by selection of the icon, link or functional indicia. If the user of the client selects a particular icon, link or functional indicia corresponding to a particular text string, the enterprise server 20 may be informed of such selection and may enable the retrieval of information corresponding to the selection made at the client. As such, for example, the enterprise server 20 may connect to the corresponding backend systems (e.g., the PDM 24 or the SAP 22) to retrieve the information. The information may then be returned to the client, which may be configured to format the returned information in a user readable format at the corresponding client.

In an exemplary embodiment, the enterprise server 20 may be configured to employ smart tags (e.g., smart tags associated with Microsoft Office® applications) and web services for implementing the methodology described herein. Thus, for example, part numbers, cost centers or other character strings of interest may be identified as corresponding to a particular text string or pattern using a smart tag. As such, for example, any character string having the format of a part number may be identified as a smart tag. As an example, a part number for a particular business unit may have a character string of xxxxxx-xxxx or xxxxxx-xA in which x is any number and A is any character of the alphabet. Other sequences or variations to the sequences listed above are also possible. However, in any case, the respective formats and/or sequences may be predefined as smart tags corresponding to part numbers in order to enable the parsing of documents for characters following the predefined formats. When characters are found that follow the predefined formats, such characters may be identified via a corresponding smart tag. For a given part number, the enterprise server 20 (e.g., via rules for smart tag definition or via operator interface) may provide options with respect to data associated with the part number that may be accessed via selection of the smart tag.

The client (e.g., client 12 or client 14) may then parse a document received or being created for a defined smart tag. In response to the client detecting the smart tag associated with the part number, the client may display indicia indicative of the identity of the smart tag or at least the existence of the smart tag to the user. As indicated above, the indicia could be a link, icon or other functional indicia. In some cases, the indicia could be application specific. For example, smart tags may be indicated in a different font or color, with underlining or another distinguishing feature, with a corresponding shape or icon, and/or the like dependent upon in which application (e.g., Word, Outlook, Excel, etc.) the smart tag is used. When a defined smart tag is selected, a corresponding function may be executed. In some cases, the function may be predefined (e.g., such as retrieving a drawing) and may automatically be performed in response to selection of the smart tag indicia. However, in other cases, several options for corresponding functionalities may be available. As such, for example, in response to selection of a part number corresponding to a smart tag for which BOM or drawings may be retrieved from respective different data management environments, the user may be provided with different selectable options (e.g., “Get drawing from PDM”, or “Get Bill of Materials from SAP”). Upon selection of one of the options, the client may then communicate the selected option to the enterprise server 20, which may invoke a corresponding web service to connect to corresponding backend systems to retrieve information associated with the selected option. When the retrieved information is provided to the client, the client may format the information for display to the user.

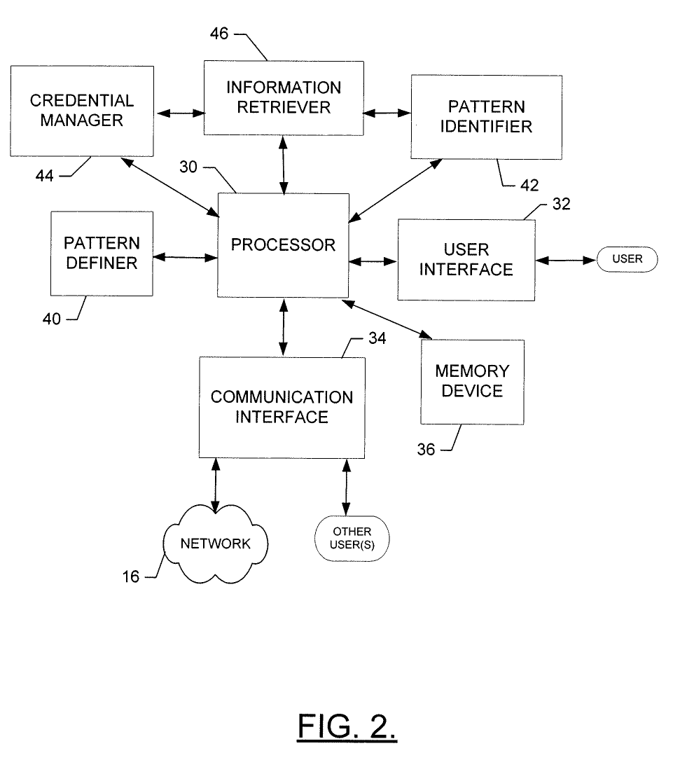

An exemplary embodiment of the invention will now be described with reference to FIG. 2, in which certain elements of an apparatus for enabling access to enterprise information according to an exemplary embodiment are displayed. The apparatus of FIG. 2 may be employed, for example, on a client (e.g., either or both of the clients 12 and 14 of FIG. 1) or a variety of other devices (such as, for example, a network device, server, proxy, or the like (e.g., the enterprise server 20 of FIG. 1)). Alternatively, embodiments may be employed on a combination of devices. Accordingly, some embodiments of the present invention may be embodied wholly at a single device (e.g., the enterprise server 20) or by devices in a client/server relationship (e.g., the enterprise server 20 and one or more clients). Furthermore, it should be noted that the devices or elements described below may not be mandatory and thus some may be omitted in certain embodiments.

Referring now to FIG. 2, an apparatus for enabling access to enterprise information is provided. The apparatus may include or otherwise be in communication with a processor 30, a user interface 32, a communication interface 34 and a memory device 36. The memory device 36 may include, for example, volatile and/or non-volatile memory. The memory device 36 may be configured to store information, data, applications, instructions or the like for enabling the apparatus to carry out various functions in accordance with exemplary embodiments of the present invention. For example, the memory device 36 could be configured to buffer input data for processing by the processor 30. Additionally or alternatively, the memory device 36 could be configured to store instructions for execution by the processor 30. As yet another alternative, the memory device 36 may be one of a plurality of databases that store information.

The processor 30 may be embodied in a number of different ways. For example, the processor 30 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 30 may be configured to execute instructions stored in the memory device 36 or otherwise accessible to the processor 30.

Meanwhile, the communication interface 34 may be any means such as a device or circuitry embodied in either hardware, software, or a combination of hardware and software that is configured to receive and/or transmit data from/to a network (e.g., the network 16) and/or any other device or module in communication with the apparatus. In this regard, the communication interface 34 may include, for example, an antenna and supporting hardware and/or software for enabling communications with a wireless communication network and/or a communication modem and/or other hardware/software for supporting communication via cable, digital subscriber line (DSL), universal serial bus (USB) or other wireline based communication mechanisms.

The user interface 32 may be in communication with the processor 30 to receive an indication of a user input at the user interface 32 and/or to provide an audible, visual, mechanical or other output to the user. As such, the user interface 32 may include, for example, a keyboard, a mouse, a joystick, a touch screen display, a display, a microphone, a speaker, or other input/output mechanisms. In an exemplary embodiment in which the apparatus is embodied as a server or some other network device, the user interface 32 may be limited, or even eliminated. However, in an embodiment in which the apparatus is embodied as a client device, the user interface 32 may include, among other devices or elements, any or all of a speaker, a microphone, a display, and a keyboard or the like.

In an exemplary embodiment, the processor 30 may be embodied as, include or otherwise control a pattern definer 40, a pattern identifier 42, a credential manager 44, and an information retriever 46. The pattern definer 40, the pattern identifier 42, the credential manager 44, and the information retriever 46 may each be any means such as a device or circuitry embodied in hardware, software or a combination of hardware and software that is configured to perform the corresponding functions of the pattern definer 40, the pattern identifier 42, the credential manager 44, and the information retriever 46, respectively, as described below. In some embodiments, an instance of each of the pattern definer 40, the pattern identifier 42, the credential manager 44, and the information retriever 46 may be included at either or both of the clients 12 and 14 (e.g., via the client application 28) and the enterprise server 20 (e.g., via the server application 26). However, in other embodiments one or more of the pattern definer 40, the pattern identifier 42, the credential manager 44, and the information retriever 46 may be instantiated at the clients 12 and 14, while at least remaining ones of the pattern definer 40, the pattern identifier 42, the credential manager 44, and the information retriever 46 are embodied at the enterprise server 20.

The pattern definer 40 may be configured to define patterns that may be recognizable and associated with a respective function or option set (e.g., including a plurality of selectable functions). In some embodiments, the pattern definer 40 may include a mechanism for assigning functions or an option set to a particular pattern or text string. For example, a user or operator may highlight a text string from an existing document or enter a text string into a field or table. The user or operator may then assign a corresponding function, or functions in the form of an option set, to the text string to define a relationship between the text string and the corresponding function or functions. Pattern definition may, in some cases, be performed in response to selection of a pattern definition mode or a pattern definition menu option. Thus, for example, after selection of the pattern definition mode or pattern definition option, a query may be provided in the form of a control console or popup window to provide fields, hot spots, or other input devices for enabling the user or operator to enter a pattern, enter a function to correspond to a highlighted or entered pattern, or the like.

In some embodiments, the user or operator may be enabled to highlight an entire column or row of data items and define each of the items as a respective pattern. Thus, for example, if a spreadsheet includes a column listing a plurality of part numbers, the user or operator may simply highlight the entire column and the pattern definer 40 may learn the format or formats of the part numbers so that other character sequences or text strings that follow the same format or formats may also be recognized as a pattern corresponding to a part number. As an alternative, the user or operator may specifically define rules for pattern definition. In this regard, for example, the user or operator may enter in a sequence such as xxxxxx-xxxA in which x is any number and A is any character of the alphabet and indicate that any sequence of characters following this format is a part number pattern that should be recognized.

In an exemplary embodiment, rules may also be defined with respect to which functions may be provided for corresponding different patterns to enable automatic association between an identified pattern and respective functions, and therefore automatic pattern definition for sequences following a defined format. For example, any sequence corresponding to a defined format for a part number may be automatically associated with options for retrieving BOM information and options for retrieving drawings from respective different data storage environments. In some embodiments, defined patterns and/or their respective different associated functions or option sets may be stored in the memory device 36. In cases where smart tags are employed, text corresponding to the pattern to be defined may initially be selected and a smart tag may be selected thereafter. Smart tags may be specific to the type of pattern identified. Thus, for example, part numbers may have one particular smart tag (with possible corresponding functions) and cost centers may have a different smart tag (with possible different corresponding functions).

The pattern identifier 42 may be configured to parse documents, web pages served, files or other content for defined patterns. In this regard, for example, the pattern identifier 42 may be configured to analyze text and/or other characters or symbols and compare text present within a particular document, web page, file, etc., to defined patterns (e.g., a stored listing of defined patterns) in order to determine whether a particular sequence of characters corresponds to a defined pattern. In an exemplary embodiment, stylesheets or cascading stylesheets may be employed for use in pattern identification. However, as an alternative, a plugin or browser may be configured to detect patterns for smart tag assignment in Internet Explorer or certain other instances. In some embodiments, if the pattern identifier 42 finds a match between a series of characters in a particular document, the pattern identifier 42 may assign the series of characters a smart tag indicating that the series of characters has been recognized as a defined pattern associated with the assigned smart tag. Once a defined pattern is identified or recognized, the pattern identifier 42 may communicate an identity of the defined pattern to the information retriever 46. As such, for example, the smart tag may be communicated to the information retriever 46, which may consume or use the smart tag as part of a process for retrieving information corresponding to the particular item associated with the defined pattern.

The information retriever 46 may be configured to receive an indication of a defined pattern and determine, for the identified pattern or smart tag, which corresponding functional indicia and/or option set corresponds to the identified pattern to enable a display of the corresponding functional indicia (e.g., by indicating that a smart tag is associated with the item corresponding to the series of characters). Accordingly, if the smart tag is selected by the user, the information retriever 46 may provide an indication of the options that may be performed with respect to the item associated with the smart tag (e.g., retrieving BOM information or drawings) or perform a respective function if a particular option is selected thereafter. In this regard, for example, the information retriever 46 may be configured to invoke operations to access information corresponding to the selected option. The invocation of such operations may include, as described above, the invocation of web services to access a respective one of different data storage environments.

In one example of operation of the information retriever 46, a defined pattern may be recognized as such by the pattern identifier 42. The pattern identifier 42 may indicate an identity of the defined pattern to the information retriever 46, which may consult a database indicating which function or options for functions correspond to the defined pattern and a corresponding smart tag for the defined pattern may be assigned. If the defined pattern corresponds to a part number, for example, the information retriever 46 may determine that options to be provided in response to selection of the smart tag include getting BOM information (e.g., from SAP 22) and getting a drawing (e.g., from PDM 24). If the user, for example, selects the smart tag and thereafter further selects the option for getting BOM information, the information retriever 46 may invoke web services for accessing SAP 22 to get BOM information for the specific part number corresponding to the defined pattern. In other words, for example, the defined pattern may simply have been recognized as a listing of numbers and/or letters that correspond to a part number format, but when the BOM information is requested by selection of the corresponding option, the specific part number associated with the selected smart tag may be determined in order to enable access to the backend system (e.g., SAP 22) that stores such information and the specific part number may be provided to the backend system to enable retrieval of the corresponding BOM information.

In some embodiments, operation as described above may be provided without significant modification. However, modifications and embellishments to the processes described above are also possible. For example, in some cases, the backend systems that store desired information (e.g., one or more of the different data storage environments) may require that individuals accessing information therein have appropriate credentials. Credentialing may be provided in many ways, such as by providing a username and password.

The credential manager 44 may be configured to save and/or use credentials to enable access to enterprise information in accordance with some embodiments of the present invention. In this regard, for example, the credential manager 44 may enable single sign on access to information stored in backend systems by storing user credentials and automatically providing such credentials to appropriate backend systems when the information retriever 46 is retrieving information from respective ones of such systems. In some cases, since different passwords or access credentials may be associated with different backend systems, the credential manager 44 may store multiple access credentials in association with each respective backend system. Thus, the credential manager 44 may then selectively utilize the access credentials depending on which backend system is being accessed. In an exemplary embodiment, the credential manager 44 may be configured to associate different access credentials with corresponding different patterns or smart tags. Such association may be further dependent upon the options for functionality associated with a respective smart tag. For example, if a part number smart tag has options including getting drawings and BOM information, the credential manager 44 may associate first access credentials with use for getting drawings from PDM 24 and second access credentials with use for getting BOM information from SAP 22.

In some instances, each request to a particular backend system may require credentialing. Thus, for example, the credential manager 44 could provide access credentials automatically to accompany each request for information provided by the information retriever 46. However, in some embodiments, in order to mitigate the potential for repeated transfers of access credentials and reduce authentication time, the credential manager 44 may be configured to maintain a session with a respective backend system for a set period of time after making a request. Accordingly, for example, in case follow-on requests come later, it may not be necessary for the credential manager 44 to repeatedly provide access credentials. Instead, a session established with a backend system for retrieval of information may be maintained for a period of time. Thus, if additional requests for information occur within the period of time, such requests may be processed without additional authentication. The period of time may be provided by a timer a length of which may be predetermined, randomly determined, or determined based upon any of a number of criteria.

In some cases a smart tag may be selected in order to provide options with respect to retrieving data in one of two different data storage environments. As such, for example, the smart tags may simply enable the retrieval of information. However, in some embodiments, smart tags may do more than just enable the retrieval of information. In this regard, smart tags may be building blocks for other smart tags. Thus, for example, a smart tag could, instead of simply providing a mechanism for retrieving information, provide a mechanism for retrieving another smart tag. As an example, engineering change notifications (ECNs) may be used to provide notice of changes to engineering practices, guidelines, or the like. ECNs could have a particular pattern that could be recognized in accordance with embodiments of the present invention and a smart tag could be assigned to an ECN. If the ECN is associated with one or more part numbers, a selection of an ECN smart tag could essentially call other smart tags associated with the associated part numbers. Additionally, smart tags according to some exemplary embodiments may enable more than just pulling of data. For example, a smart tag could also be used to update backend systems. Thus, for example, a smart tag could be used to access information that may be modifiable. After modification of the information, the backend system (e.g., SAP or PDM) may be updated to reflect the changes made. In an exemplary embodiment, an ECN smart tag could be selected and information associated with the ECN may be retrieved from a backend system and provided to the user. The information retrieved could include a mechanism for approving or rejecting the ECN. Based on the selection (e.g., approval or rejection) made, the backend system could then be updated to reflect the status of the ECN.

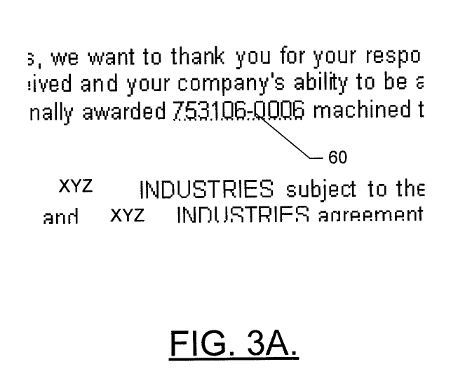

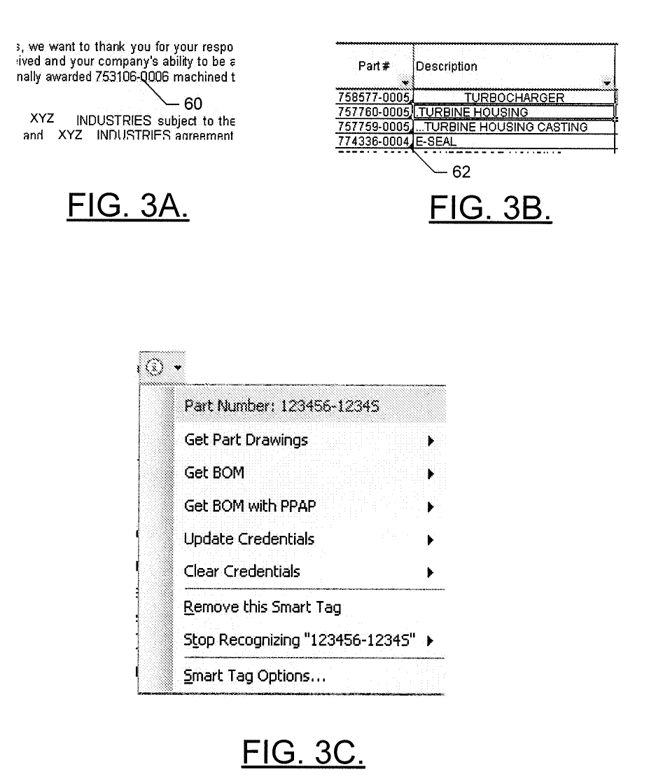

FIG. 3 (including FIGS. 3A, 3B and 3C) illustrates examples of smart tags and operation with respect to smart tags in accordance with an exemplary embodiment. In this regard, for example, FIG. 3A illustrates an example of a smart tag 60, which may be located in text associated with a document (e.g., a Microsoft Word® document) or displayed on a web page (e.g., an Internet Explorer® web page). The smart tag 60 is indicated by virtue of underlining the portion of the text that corresponds to the recognized pattern. FIG. 3B illustrates an example of a smart tag 62 in a spreadsheet (e.g., a Microsoft Excel® spreadsheet). The smart tag 62 may be indicated by a triangle in a corner of a data field of the spreadsheet that includes the recognized pattern. FIG. 3C illustrates an example of options that may be provided in response to selection of a smart tag (e.g., a smart tag corresponding to a part number). As shown in FIG. 3C, the smart tag may be identified along with one or more selectable options that may be selected to invoke corresponding functionalities.

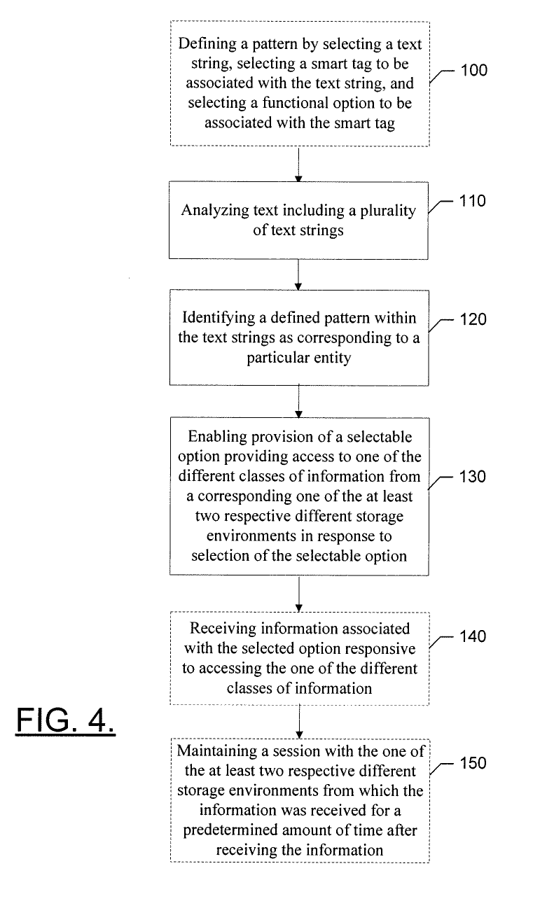

FIG. 4 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a computing device, and executed by a processor of the computing device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing management of inventory related events, as shown in FIG. 4, includes analyzing text including a plurality of text strings at operation 110 and identifying a defined pattern within the text strings as corresponding to a particular entity at operation 120. The particular entity may be associated with different classes of information stored in at least two respective different storage environments. In some cases, the particular entity may be a part number, a cost center or any other item, individual, group, product, or the like. The analyzed text could be associated with a web page, a document, file, database or other object. The method may further include enabling provision of a selectable option providing access to one of the different classes of information from a corresponding one of the at least two respective different storage environments in response to selection of the selectable option at operation 130.

In some embodiments, additional optional operations may also be performed. Some examples of optional operations are shown in FIG. 4 in dashed lines. For example, the method may further include operation 100 of defining the defined pattern by selecting a text string, selecting a smart tag to be associated with the text string, and selecting a functional option to be associated with the smart tag. In an exemplary embodiment, defining the pattern may include highlighting a plurality of different series of text characters and analyzing each highlighted series to determine one or more formats for the pattern based on the respective characteristics of the different series. The method may also include receiving information associated with the selected option responsive to accessing the one of the different classes of information at operation 140. Receiving the information may include receiving the information in response to automatic provision of stored access credentials enabling access to the one of the at least two respective different storage environments from which the information was received based on the selected option. In some embodiments, the method may also include maintaining a session with the one of the at least two respective different storage environments from which the information was received for a predetermined amount of time after receiving the information at operation 150.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
analyzing text including a plurality of text strings;
identifying a defined pattern within the text strings as corresponding to a particular entity, the particular entity being associated with different classes of information stored in at least two respective different storage environments; and
enabling provision of a selectable option providing access to one of the different classes of information from a corresponding one of the at least two respective different storage environments in response to selection of the selectable option.

2. The method of claim 1, further comprising an initial operation of defining the defined pattern by selecting a text string, selecting a smart tag to be associated with the text string, and selecting a functional option to be associated with the smart tag.

3. The method of claim 2, wherein defining the pattern comprises highlighting a plurality of different series of text characters and analyzing each highlighted series to determine one or more formats for the pattern based on the respective characteristics of the different series.

4. The method of claim 2, wherein selecting the functional option comprises defining an additional smart tag to be called in response to selection of the smart tag.

5. The method of claim 1, wherein analyzing text comprises analyzing text in a web page.

6. The method of claim 1, further comprising receiving information associated with the selected option responsive to accessing the one of the different classes of information.

7. The method of claim 6, wherein receiving the information comprises receiving the information in response to automatic provision of stored access credentials enabling access to the one of the at least two respective different storage environments from which the information was received based on the selected option.

8. The method of claim 7, further comprising maintaining a session with the one of the at least two respective different storage environments from which the information was received for a predetermined amount of time after receiving the information.

9. A computer program product comprising at least one computer-readable storage medium having computer-readable program code portions stored therein, the computer-readable program code portions comprising:
a first executable portion for analyzing text including a plurality of text strings;
a second executable portion for identifying a defined pattern within the text strings as corresponding to a particular entity, the particular entity being associated with different classes of information stored in at least two respective different storage environments; and
a third executable portion for enabling provision of a selectable option providing access to one of the different classes of information from a corresponding one of the at least two respective different storage environments in response to selection of the selectable option.

10. The computer program product of claim 9, further comprising a fourth executable portion for defining the defined pattern by selecting a text string, selecting a smart tag to be associated with the text string, and selecting a functional option to be associated with the smart tag.

11. The computer program product of claim 10, wherein the fourth executable portion includes instructions for highlighting a plurality of different series of text characters and analyzing each highlighted series to determine one or more formats for the pattern based on the respective characteristics of the different series.

12. The computer program product of claim 10, wherein the fourth executable portion includes instructions for defining an additional smart tag to be called in response to selection of the smart tag.

13. The computer program product of claim 9, wherein the first executable portion includes instructions for analyzing text in a web page.

14. The computer program product of claim 9, further comprising a fourth executable portion for receiving information associated with the selected option responsive to accessing the one of the different classes of information.

15. The computer program product of claim 14, wherein the fourth executable portion includes instructions for receiving the information in response to automatic provision of stored access credentials enabling access to the one of the at least two respective different storage environments from which the information was received based on the selected option.

16. The computer program product of claim 15, further comprising a fifth executable portion for maintaining a session with the one of the at least two respective different storage environments from which the information was received for a predetermined amount of time after receiving the information.

17. An apparatus comprising:
a pattern identifier configured to analyze text including a plurality of text strings and identify a defined pattern within the text strings as corresponding to a particular entity, the particular entity being associated with different classes of information stored in at least two respective different storage environments; and
an information retriever configured to enable provision of a selectable option providing access to one of the different classes of information from a corresponding one of the at least two respective different storage environments in response to selection of the selectable option.

18. The apparatus of claim 17, further comprising a pattern definer configured to define the defined pattern by selecting a text string, selecting a smart tag to be associated with the text string, and selecting a functional option to be associated with the smart tag.

19. The apparatus of claim 18, wherein the pattern definer is further configured to enable highlighting a plurality of different series of text characters and to analyze each highlighted series to determine one or more formats for the pattern based on the respective characteristics of the different series.

20. The apparatus of claim 18, wherein the pattern definer is further configured to define an additional smart tag to be called in response to selection of the smart tag.

21. The apparatus of claim 18, wherein the pattern identifier is configured to analyze text including analyzing text in a web page.

22. The apparatus of claim 18, wherein the information retriever is further configured to receive information associated with the selected option responsive to accessing the one of the different classes of information.

23. The apparatus of claim 22, wherein the information retriever is further configured to receive the information in response to automatic provision of stored access credentials by a credential manager enabling access to the one of the at least two respective different storage environments from which the information was received based on the selected option.

24. The apparatus of claim 23, wherein the credential manager is further configured to maintain a session with the one of the at least two respective different storage environments from which the information was received for a predetermined amount of time after receiving the information.
